(19) United States
(12) Patent Application Publication
(10) Pub. No.: US 2026/0030389 A1
(43) Pub. Date: Jan. 29, 2026

(54) METHOD FOR CARRYING OUT SECURE COMPARISON WITH ZERO AND ASSOCIATED ELECTRONIC DEVICE AND COMPUTER PROGRAM

(71) Applicant: IDEMIA FRANCE, Courbevoie (FR)

(72) Inventors: Luk BETTALE, Courbevoie (FR); Elie EID, Courbevoie (FR); Matthias TRANNOY, Courbevoie (FR)

(73) Assignee: IDEMIA FRANCE, Courbevoie (FR)

(21) Appl. No.: 19/196,062

(22) Filed: May 1, 2025

(30) Foreign Application Priority Data
Jul. 29, 2024 (FR) FR2408381

(51) Int. Cl. G06F 21/72

(52) U.S. Cl. CPC G06F 21/72

(57) ABSTRACT

A method for carrying out secure comparison with zero of a masked input datum taking the form of a first set of n first shares of a modular additive mask, and comprising the following steps: determining a second set of intermediate data from the first shares, determining a third set of third shares of a Boolean mask of the result of the comparison from the intermediate data, the second set having a partition into a first subset and a second subset such that a result obtained by combination with exclusive-or operations of zero and of the intermediate data of the first subset, is equal to a result obtained by combination with exclusive-or operations of zero and of the intermediate data of the second subset, when and only when the input datum is equal to 0.

### FIELD

The present invention relates to the field of computer cryptography. It relates more particularly to a method for carrying out secure comparison with zero. The invention also relates to an associated electronic device and an associated computer program.

### BACKGROUND

In a known manner, a cryptographic algorithm may be used to encrypt, decrypt, sign or verify the signature of a datum. Such a cryptographic algorithm is, for example, a cryptographic algorithm employing asymmetric keys implemented by an electronic device, and typically an RSA algorithm or an elliptic-curve algorithm implemented by the chip of a chip card.

The emergence of quantum computers makes these cryptographic algorithms unsafe.

It would therefore be desirable to adapt cryptographic algorithms to guarantee security against an attacker employing a quantum computer. Such cryptographic algorithms are called post-quantum cryptographic algorithms.

In cryptographic algorithms, many procedures need to test whether a given variable is zero or not.

Cryptographic algorithms may need to test one or more data to verify whether they are equal to zero or not.

When a comparison with zero needs to handle secret data and the result of the test must be kept secret, masking must be used to secure the process against side-channel attacks.

There are a number of existing methods for carrying out comparison with zero of a masked input datum taking the form of a first set of first shares of a modular additive mask of modulus q.

However, the result of the comparison is generally an unmasked output datum that is equal to 1 if the input datum is equal to 0, and 0 if the input datum is not equal to 0. These methods are therefore vulnerable to side-channel analysis.

The document “Jean-Sébastien Coron, François Gérard, Simon Montoya, and Rina Zeitoun, High-order polynomial comparison and masking lattice-based encryption. IACR Trans. on Cryptographic Hardware And Embedded Systems, DOI: 10.46586, 2023(1): 153-192, 2023” describes a method for carrying out secure comparison with zero of a masked input datum taking the form of a first set of first shares of a modular additive mask of modulus q, the result of said comparison being of masked form.

However, this method places great demands on the electronic device. Furthermore, this method is limited to a modulus q that is a prime number.

### SUMMARY

In order to remedy these drawbacks, the present invention provides, according to a first aspect, a method for carrying out secure comparison with zero of a masked input datum taking the form of a first set of n first shares of a modular additive mask, n being an integer strictly greater than 1, the method being implemented by an electronic device and the method comprising the following steps:
determining a second set of n intermediate data from the n first shares,
determining a third set of third shares of a Boolean mask of a result of the comparison from the intermediate data,
   the method being characterized in that the step of determining a second set of n intermediate data from the n first shares determines a second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0.

The following are further advantageous and non-limiting features of the method according to the invention, which may be implemented alone or in any technically possible combination:
the modular additive mask is of non-zero modulus q;
the first result is equal to a sum modulo the modulus q of the first shares of a third subset, and the second result is equal to a sum modulo the modulus q of the opposites of the first shares of a fourth subset;
the third subset and the fourth subset are a partition of the first set;
n is equal to 2, the intermediate datum of the first subset is a first share, and the intermediate datum of the second subset is the opposite modulo the modulus q of a first share distinct from the first share of the first subset;
n is strictly greater than 2, the intermediate data of the first subset are a Boolean mask of a partial input datum, the first shares of the third subset being a modular additive mask of modulus q of the partial input datum, and the intermediate data of the second subset are a Boolean mask of another partial input datum, the opposites modulo the modulus q of the first shares of the fourth subset being a modular additive mask of modulus q of the other partial input datum;
the step of determining a second set of n intermediate data from the n first shares comprises determining the third subset and the fourth subset, determining the intermediate data of the first subset by applying an algorithm for converting a modular additive mask into a Boolean mask to the first shares of the third subset, and determining the intermediate data of the second subset by applying an algorithm for converting a modular additive mask into a Boolean mask to the opposites modulo the modulus q of the first shares of the fourth subset;
the first subset and the second subset have a cardinal difference less than or equal to 1;
the step of determining the third set treats all the intermediate data of the second set as second shares of a Boolean mask;
each intermediate datum has a size of k bits and a rank i of between 1 and n, k being strictly greater than 1;
each third share has a size of 1 bit and a rank i of between 1 and n;
determining the third set of the third shares comprises implementing an initialization of one third share of the third set to I and of the other third shares of said third set to 0, then updating an intermediate datum of same rank as the third share initialized to 1, with the one's complement of said intermediate datum of same rank, then implementing k substeps of updating the third shares of the third set, said updating substeps having respective indices ranging from 0 to k−1, each substep performing a calculation defined as follows:

$$( {b}_{1} , … , {b}_{n} ) ← SecAnd ( 1 , ( {b}_{1} , … , {b}_{n} ) , ( {y}_{1}^{j} , … , {y}_{n}^{j} ) )$$

with SecAnd a secure implementation of the Boolean operator AND, yᵢ^{j} the bit of rank j of the intermediate datum of rank i, bᵢ the third share of rank i, j having as value the index of the substep in question;
secure implementation of the Boolean operation AND of the substep of index j updates the third shares such that:

$${⊕}_{i = 1}^{n} {b}_{i} = ( {⊕}_{i = 1}^{n} {b}_{i} ) ∧ ( {⊕}_{i = 1}^{n} {y}_{i}^{j} )$$

with ⊕ the exclusive-or operation and ∧ the Boolean operator AND;
the method is implemented in a cryptographic algorithm;
the cryptographic algorithm is an algorithm among the Hamming Quasi-Cyclic algorithm, the FrodoKEM algorithm and the Crystals-Kyber algorithm.

According to a second aspect, the invention provides a computer program comprising instructions executable by a processor and configured to implement a method for carrying out secure comparison with zero such as defined above, when these instructions are executed by the processor.

This program may use any programming language, and take the form of source code, object code, or code intermediate between source code and object code, such as code in a partially compiled form, or in any other desirable form.

At least some of the methods according to the invention may be computer-implemented. As a result, the present invention may be embodied entirely in the form of hardware, entirely in the form of software (comprising firmware, resident software, microcode, etc.) or in a form combining software and hardware aspects that may each be generally referred to as “blocks” here.

According to a third aspect, the invention provides an electronic device capable of carrying out secure comparison with zero of a masked input datum taking the form of a first set of n first shares of a modular additive mask, n being an integer strictly greater than 1, the electronic device comprising:
a block for determining a second set of n intermediate data, which is configured to determine a second set of n intermediate data from the n first shares,
a block for determining a third set of third shares, which is configured to determine a third set of third shares of a Boolean mask of a result of the comparison from the intermediate data, the electronic device being characterized in that the block for determining a second set of n intermediate data is configured to determine a second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0.

This electronic device may be configured to implement each of the possible embodiments of the method for carrying out secure comparison with zero defined above.

Of course, the various features, variants and embodiments of the invention may be combined with one another in a variety of combinations provided that they are not incompatible or mutually exclusive.

Other features and advantages of the present invention will become apparent from the description given below, with reference to the appended figures, which illustrate examples of embodiment that are completely non-limiting in nature.

### BRIEF DESCRIPTION OF THE DRAWINGS

In the figures:

FIG. 1 schematically shows one preferred embodiment of an electronic device according to the invention;

FIG. 2 illustrates, in the form of a flowchart, the main steps of a secure comparison with zero according to a first embodiment of the invention;

FIG. 3 illustrates, in the form of a flowchart, the main steps of a secure comparison with zero according to a second embodiment of the invention.

### DETAILED DESCRIPTION

Unless otherwise indicated, elements common to a plurality of figures or analogous elements in a plurality of figures have been designated with the same reference signs and have identical or analogous features, and hence these common elements have generally not been described more than once for the sake of simplicity.

In the context of the present description, the qualifiers “first”, “second”, “third” and “fourth” are used merely by way of indication to distinguish between the elements that they qualify, and do not imply an order thereof.

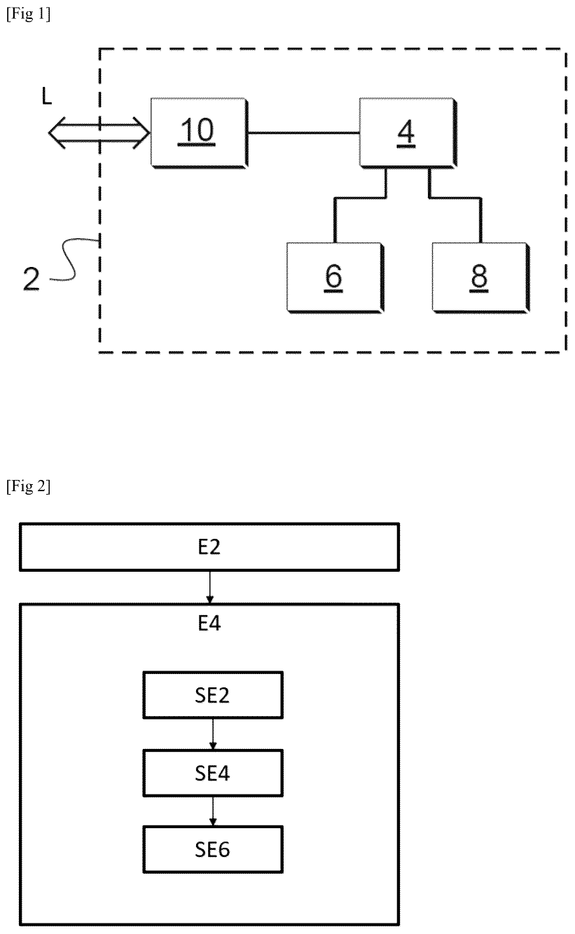

FIG. 1 schematically shows an electronic device 2 comprising a processor 4 (for example a microprocessor), a storage entity 6, a random-access memory 8 and a communication entity 10.

The random-access memory 8 and the storage entity 6 are each connected to the processor 4 such that the processor 4 may read or write data from or to the storage entity 6 and/or the random-access memory 8.

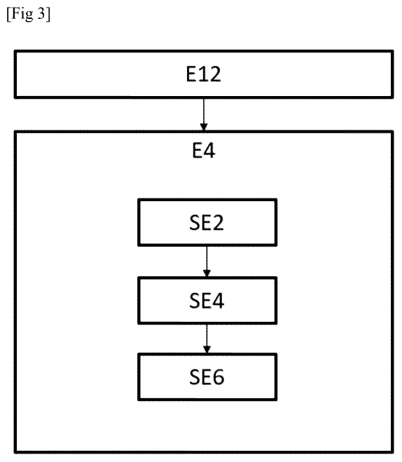

The storage entity 6 stores computer program instructions, some of which are designed to implement a method such as described with reference to FIGS. 2 and 3 when these instructions are executed by the processor 4.

The storage unit 6 is for example a hard drive or a non-volatile memory that is optionally rewritable, and for example an electrically erasable and programmable read-only memory (EEPROM).

The random-access memory 8 may for its part store at least some of the elements (first shares, intermediate data and/or third shares as described with reference to at least one of FIGS. 2 and 3) handled during the various processing operations performed in one of the methods described below.

In the remainder of the description, each of the storage entity 6 and the random-access memory 8 will be referred to as memory.

The electronic device 2 also comprises a plurality of blocks (not shown).

Typically, the electronic device 2 comprises a block for determining a second set of n intermediate data and a block for determining a third set of third shares.

The electronic device 2 may further comprise a cryptographic block.

Each block has a functionality described in one of the methods according to the invention and described below with reference to FIGS. 2 and 3. Thus, for each block, the electronic device 2 for example stores software instructions that are executable by the processor 4 of the electronic device 2 in order to use a hardware element (for example a communication entity or a memory) and thus implement the functionality provided by the block.

According to one possible embodiment, the computer program instructions stored in the storage entity 6 were for example received (typically from a remote computer) during a phase of operation of the electronic device 2 prior to implementation of the methods described with reference to FIGS. 2 and 3.

The communication entity 10 is connected to the processor 4 so as to allow the processor 4 to receive data from another electronic device (not shown) and/or to transmit data to another electronic device (not shown). In certain embodiments, the processor 4 may thus receive a datum L from the other electronic device, for example the computer program instructions and/or an input message, and/or send an output message. An input message is, for example, a message that the electronic device 2 must sign using a cryptographic key, the signature comprising a secure comparison with zero of a datum with a method as described with reference to FIG. 2 or 3. An output message is for example the result of said signature.

The electronic device 2 may take many forms (not shown).

According to a first example, the electronic device is a chip card, such as an identity card, a bank card or a universal integrated circuit card (also known as a UICC).

In this case, the communication entity 10 for example comprises contacts flush with one face of the chip card. As a variant, the communication entity 10 could be implemented by a contactless communication block. Generally, the communication entity 10 may be a wired or wireless communication block for communicating with another electronic device.

According to a second example, the electronic device is a secure element, such as a secure microcontroller, that is integrated into another electronic device, typically a communication terminal or a car.

According to other examples, the electronic device is a USB key, a mobile telephone, a personal computer, a server or an identity document, such as an electronic passport.

As will be seen hereinafter, the electronic device 2 is configured to make a secure comparison with zero of a masked input datum taking the form of a first set of n first shares of a modular additive mask, typically of modulus q. The electronic device 2 may further be configured to implement a cryptographic algorithm comprising at least one secure comparison with zero according to a method of the invention, for example as described with reference to FIG. 2 or FIG. 3.

Typically, the cryptographic algorithm is implemented by the cryptographic block of the electronic device 2.

According to one example of modular additive masking, a quantity A is masked additively modulo a modulus B with n shares if it is given in the form of n quantities A₁, . . . , Aₙ such that the following equation is satisfied: A₁+ . . . +Aₙ=A mod B. In this example, the quantity A is said to be masked in the form of n shares A₁, . . . , Aₙ of a modular additive mask of modulus B, and the shares A₁, . . . , Aₙ are said to be a modular additive mask of modulus B of the quantity A.

According to an example of Boolean masking, a quantity A is masked in the form of n quantities A₁, . . . , Aₙ such that the following equation is satisfied: A₁ ⊕ . . . ⊕ Aₙ=A, with ⊕ the exclusive-or operation. In this example, the quantity A is said to be masked in the form of n shares A₁, . . . , Aₙ of a Boolean mask, and the shares A₁, . . . , Aₙ are said to be a Boolean mask of the quantity A.

FIG. 2 illustrates, in the form of a flowchart, the main steps of a secure comparison with zero according to a first embodiment of the invention. More precisely, FIG. 2 illustrates the main steps of a secure comparison with zero of a masked input datum taking the form of a first set of n first shares of a modular additive mask of modulus q, n being an integer strictly greater than 1.

The modulus q is a non-zero integer. In this embodiment of the invention, the integer n is equal to 2.

Typically, x=(x₁+x₂) mod q with x the input datum, and x₁ and x₂ the first shares of the first set.

The secure comparison with zero is here implemented by the electronic device 2 as a result of execution of the computer program instructions stored in the storage entity 6 as indicated above.

The method may be implemented in a cryptographic algorithm.

The method thus allows this cryptographic algorithm to be implemented in a device having limited computational resources, and typically in a secure element, a chip card, a USB key or an identity document.

The cryptographic algorithm may be an algorithm among the Hamming Quasi-Cyclic algorithm, the FrodoKEM algorithm and the Crystals-Kyber algorithm.

The method is particularly advantageous in the context of these algorithms, which require many secure comparisons with zero.

In a step (step E2) of determining a second set of n intermediate data, the processor 4 determines a second set of n intermediate data from the n first shares, the second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0, i.e. if and only if the input datum is equal to 0. Typically, the processor 4 determines the intermediate datum of the first subset to be a first share and the intermediate datum of the second subset to be the opposite modulo the modulus q of a first share distinct from the first share of the first subset, i.e. of a first share of the first set, distinct from the first share of the first subset. For example, the processor 4 determines an intermediate datum y₁ of the first subset and an intermediate datum y₂ of the second subset as follows: y₁=x₁ mod q and y₂=−x₂ mod q.

The first subset and the second subset are such that:
the first result is equal to a sum modulo the modulus q of the first shares of a third subset, and
the second result is equal to a sum modulo the modulus q of the opposites of the first shares of a fourth subset,
the third subset and the fourth subset being a partition of the first set.

In this example, the first set is {x₁,x₂}, the second set is {y₁,y₂}, the first subset is {y₁}, the second subset is {y₂}, the third subset is {x₁}, the fourth subset is {x₂}, the value of the first result is 0⊕y₁=y₁, the value of the second result is 0⊕y₂=y₂. the value of the sum modulo the modulus q of the first shares of the third subset is x₁ mod q, and the value of the sum modulo the modulus q of the opposites of the first shares of the fourth subset is −x₂ mod q. Thus, the result of the combination by exclusive-or of the first result and of the second result is equal to 0 if the input datum is equal to 0) and to a non-zero value if the input datum is not equal to 0.

Specifically, the equality x=0 is equivalent to the equality (x₁+x₂) mod q=0 because x=(x₁+x₂) mod q.

However, the equality 0=(x₁+x₂) mod q is equivalent to the equality x₁ mod q=—x₂ mod q, i.e. to the equality 0⊕y₁=0⊕y₂ and to the equalities (x₁ mod q)⊕(−x₂ mod q)=0 and y₁⊕y₂=0.

It will be noted that it is not necessary to calculate the first result or second result to determine a second set of n intermediate data having a partition into a first subset and second subset with one or more of the following features:
the first result obtained by combination with exclusive-or operations of zero and of the intermediate data of the first subset is equal to a second result obtained by combination with exclusive-or operations of zero and of the intermediate data of the second subset, when and only when the input datum is equal to 0,
the first result obtained by combination with exclusive-or operations of zero and of the intermediate data of the first subset is equal to a sum modulo the modulus q of the first shares of the third subset,
the second result obtained by combination with exclusive-or operations of zero and of the intermediate data of the second subset, is equal to a sum modulo the modulus q of the opposites of the first shares of the fourth subset.

The step of determining a second set of n intermediate data (step E2) is typically implemented by the block for determining a second set of n intermediate data of the electronic device 2. The method then comprises a step (step E4) of determining a third set of third shares of a Boolean mask of a result of the comparison from the intermediate data.

Typically, the third set determining step treats all intermediate data of the second set as second shares of a Boolean mask.

The third set of third shares may be determined from the intermediate data using techniques known to those skilled in the art, for example using a first technique described in Appendices C1 and C3 of the document “Jean-Sébastien Coron, François Gérard, Simon Montoya, and Rina Zeitoun, High-order polynomial comparison and masking lattice-based encryption. IACR Trans. On Cryptographic Hardware And Embedded Systems, DOI: 10.46586, 2023(1): 153-192, 2023”.

In this example, each intermediate datum has a size of k bits and a rank i of between 1 and n, k being strictly greater than 1. Each third share has a size of one bit and a rank i of between 1 and n.

Determining the third set of the third shares comprises implementing an initialization (substep SE2) of one third share of the third set to 1 and of the other third shares of said third set to 0, then updating an intermediate datum (substep SE4) of same rank as the third share initialized to 1, with the one's complement of said intermediate datum of same rank, then implementing k substeps (the k substeps have been illustrated in the form of a group designated by the reference SE6) of updating the third shares of the third set, said updating substeps having respective indices ranging from 0 to k−1, each substep performing a calculation defined as follows:

$$( {b}_{1} , … , {b}_{n} ) ← SecAnd ( 1 , ( {b}_{1} , … , {b}_{n} ) , ( {y}_{1}^{j} , … , {y}_{n}^{j} ) )$$

with SecAnd a secure implementation of the Boolean operator AND, yᵢ^{j} the bit of rank j of the intermediate datum of rank i, bᵢ the third share of rank i, j having as value the index of the substep in question. Furthermore, the secure implementation of the Boolean operation AND of the substep of index j updates the third shares such that:

$${⊕}_{i = 1}^{n} {b}_{i} = ( {⊕}_{i = 1}^{n} {b}_{i} ) ∧ ( {⊕}_{i = 1}^{n} {y}_{i}^{j} )$$

with ⊕ the exclusive-or operation and ∧ the Boolean operator AND.

The AND Boolean operation may be implemented securely using techniques known to those skilled in the art, for example using the technique described in Appendix CI of the document “Jean-Sébastien Coron, François Gérard, Simon Montoya, and Rina Zeitoun, High-order polynomial comparison and masking lattice-based encryption. IACR Trans. on Cryptographic Hardware And Embedded Systems, DOI: 10.46586, 2023(1): 153-192, 2023”.

In another example, the third set of third shares may be determined from the intermediate data using a second technique, which is described in Appendix C4 of the document “Jean-Sébastien Coron, François Gérard, Simon Montoya, and Rina Zeitoun, High-order polynomial comparison and masking lattice-based encryption. IACR Trans. on Cryptographic Hardware And Embedded Systems, DOI: 10.46586, 2023(1): 153-192, 2023”.

The method is thus particularly advantageous because it does not require any conversion of a modular additive mask into a Boolean mask.

The method is in particular advantageous because it allows a secure comparison with zero of the input datum without converting the modular additive mask of the input datum into a Boolean mask of said input datum.

The first subset and second subset have a cardinal difference less than or equal to 1. In other words, the difference between the cardinal of the first subset and the cardinal of the second subset is less than or equal to 1. Indeed, it will be noted that in the embodiment described with reference to FIG. 2, the cardinal of the first subset is equal to the cardinal of the second subset.

The step of determining the third set may treat all the intermediate data of the second set as shares of the same Boolean mask although said intermediate data are not.

This is made possible by the step of determining a second set of n intermediate data as described above because the result of the combination via an exclusive-or of the first result and of the second result is equal to 0 if the input datum is equal to 0 and to a non-zero value if the input datum is not equal to 0.

In other words, this is enabled by a feature of the second set determined during the method, i.e. by the fact that the second set of n intermediate data has a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0, i.e. if and only if the input datum is equal to 0.

The second set determined during the method also has the feature that its partition into the first subset and the second subset is such that:
the first result is equal to a sum modulo the modulus q of the first shares of the third subset, and
the second result is equal to a sum modulo the modulus q of the opposites of the first shares of the fourth subset.

The method is also advantageous because it allows the use of any modulus q, i.e. a modulus q that is not a prime number.

The step of determining a third set of third shares of a Boolean mask of a result of the comparison (step E4) is typically implemented by the block for determining a third set of third shares of the electronic device 2.

FIG. 3 illustrates, in the form of a flowchart, the main steps of a secure comparison with zero according to a second embodiment of the invention. More precisely, FIG. 3 illustrates the main steps of a secure comparison with zero of a masked input datum taking the form of a first set of n first shares of a modular additive mask of modulus q, n being an integer strictly greater than 1.

The modulus q is a non-zero integer. In this embodiment of the invention, the integer n is strictly greater than 2.

Typically, x=(x₁+ . . . +xₙ) mod q with x the input datum and x₁, . . . , xₙ the n first shares of the first set.

The secure comparison with zero is here implemented by the electronic device 2 as a result of execution of the computer program instructions stored in the storage entity 6 as indicated above.

The method may be implemented in a cryptographic algorithm.

The method thus allows this cryptographic algorithm to be implemented in a device having limited computational resources, and typically in a secure element, a chip card, a USB key or an identity document.

The cryptographic algorithm may be an algorithm among the Hamming Quasi-Cyclic algorithm, the FrodoKEM algorithm and the Crystals-Kyber algorithm.

The method is particularly advantageous in the context of these algorithms, which require many secure comparisons with zero.

In a step (step E12) of determining a second set of n intermediate data, the processor 4 determines a second set of n intermediate data from the n first shares, the second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0, i.e. if and only if the input datum is equal to 0. Typically, the processor 4 determines:
the intermediate data of the first subset to be a Boolean mask of a partial input datum, the first shares of a third subset being a modular additive mask of modulus q of the partial input datum, and
the intermediate data of the second subset to be a Boolean mask of another partial input datum, the opposites modulo the modulus q of the first shares of a fourth subset being a modular additive mask of modulus q of the other partial input datum,
the third subset and fourth subset being a partition of the first set.

The first subset and the second subset are such that:
the first result is equal to a sum modulo the modulus q of the first shares of a third subset, and
the second result is equal to a sum modulo the modulus q of the opposites of the first shares of a fourth subset. For example, the processor 4 determines m intermediate data y₁, . . . , yₘ such that y₁⊕ . . . ⊕yₘ=(x₁+ . . . +xₘ) mod q and n−m intermediate data yₘ₊₁, . . . , yₙ such that yₘ₊₁⊕ . . . ⊕yₙ=(−xₘ₊₁− . . . −xₙ) mod q, m being an integer between 1 and n−1.

In this example, the first set is {x₁, . . . , xₙ}, the second set is {y₁, . . . , yₙ}; the first subset is {y₁, . . . , yₘ}, the second subset is {yₘ₊₁, . . . , yₙ}, the third subset is {x₁, . . . , xₘ}. the fourth subset is {xₘ₊₁, . . . , xₙ}, the value of the first result is 0⊕y₁ . . . ⊕yₘ=y₁ . . . ⊕yₘ, the value of the second result is 0⊕yₘ₊₁ . . . ⊕yₙ =yₘ₊₁ . . . ⊕yₙ, the value of the sum modulo the modulus q of the first shares of the third subset is (x₁+ . . . +xₘ) mod q, and the value of the sum modulo the modulus q of the opposites of the first shares of the fourth subset is (−xₘ₊₁−. . . −xₙ) mod q.

According to one implementation, the processor 4 may determine the third subset by selecting m first shares of the first set, m being an integer between 1 and n−1. The processor 4 may then determine the fourth subset by selecting n-m first shares of the first set, said n-m first shares being distinct from the m shares selected beforehand to determine the third subset.

It is possible to use other implementations to determine the third and fourth subsets.

Thus, according to a first other implementation, the processor 4 may determine the third and fourth subsets by selecting one or more first shares of the first set in turn for the third and fourth subsets, the one or more first shares selected in a given round being distinct from the one or more first shares selected in previous rounds.

According to a second other implementation, the processor 4 associates at least a first share of the first set, randomly or pseudo-randomly, with the third subset or fourth subset.

After determining the third subset, the processor may then determine the intermediate data of the first subset by applying an algorithm for converting a modular additive mask into a Boolean mask to the first shares of the third subset.

After determining the fourth subset, the processor may also determine the intermediate data of the second subset by applying an algorithm for converting a modular additive mask into a Boolean mask to the opposites modulo the modulus q of the first shares of the fourth subset. Typically, in the example described above, the processor may determine the intermediate data of the second subset by applying an algorithm for converting a modular additive mask into a Boolean mask with −xₘ₊₁ mod q, . . . , −xₙ mod q.

A modular additive mask may be converted into a Boolean mask using a known algorithm, for example as described in the document “Jean-Sébastien Coron, Johann Großschädl, and Praveen Kumar Vadnala, Secure conversion between boolean and arithmetic masking of any order. In Proceedings of CHES 2014, pages 188-205, 2014”, or as described in the document “Jean-Sébastien Coron, François Gérard, Simon Montoya, and Rina Zeitoun, High-order table-based conversion algorithms and masking lattice-based encryption. IACR Trans. Cryptogr. Hardw. Embed. Syst., 2022(2): 1-40, 2022”.

Thus, the result of the combination by exclusive-or of the first result and of the second result is equal to 0 if the input datum is equal to 0 and to a non-zero value if the input datum is not equal to 0.

Specifically, the equality x=0 is equivalent to the equality (x₁ + . . . +xₙ) mod q=0 because x=(x₁+ . . . +xₙ) mod q.

However, the equality 0=(x₁+ . . . +xₙ) mod q is equivalent to the equality (x₁+ . . . +xₘ)=−(xₘ₊₁+ . . . +xₙ) mod q=(−xₘ₊₁ . . . xₙ) mod q, i.e. to the equality 0⊕y₁⊕ . . . ⊕yₘ=0⊕yₘ₊₁⊕ . . . ⊕yₙ, and therefore to the equality (y₁⊕ . . . ⊕yₘ)+(yₘ₊₁⊕ . . . ⊕yₙ) =0.

It will be noted that it is not necessary to calculate the first result or second result to determine a second set of n intermediate data having a partition into a first subset and second subset with one or more of the following features:
the first result obtained by combination with exclusive-or operations of zero and of the intermediate data of the first subset is equal to a second result obtained by combination with exclusive-or operations of zero and of the intermediate data of the second subset, when and only when the input datum is equal to 0,
the first result obtained by combination with exclusive-or operations of zero and of the intermediate data of the first subset is equal to a sum modulo the modulus q of the first shares of the third subset,
the second result obtained by combination with exclusive-or operations of zero and of the intermediate data of the second subset is equal to a sum modulo the modulus q of the opposites of the first shares of the fourth subset.

The step of determining a second set of n intermediate data (step E12) is typically implemented by the block for determining a second set of n intermediate data of the electronic device 2.

The method then comprises a step (step E4) of determining a third set of third shares of a Boolean mask of the result of the comparison from the intermediate data, which step is identical to the one described with reference to FIG. 2.

The method is thus advantageous because it allows a secure comparison with zero of the input datum without converting the modular additive mask of the input datum into a Boolean mask of said input datum. On the contrary, the method converts the modular additive mask of modulus q of a partial input datum or of another partial input datum, into a Boolean mask of said partial input datum or of said other partial input datum, respectively.

The partial input datum, or the other partial input datum, is masked in the form of a number of shares strictly less than n. Typically, the partial input datum is masked in the form of m shares and the other partial input datum is masked in the form of n-m shares.

The conversions of masks of the partial input datum and of the other partial input datum thus consume fewer computing resources of the electronic device than conversion of the mask of the input datum.

According to techniques known to those skilled in the art, algorithms for converting a modular additive mask to a Boolean mask generally have a quadratic asymptotic complexity.

Typically, the complexity of the conversion of the modular additive mask of modulus q of the input datum into a Boolean mask of said input datum is C·log₂(q)·n² with C a complexity coefficient.

The complexity of the conversion of the modular additive mask of modulus q of the partial input datum into a Boolean mask of said partial input datum is C·log²(q)·m² with m the cardinal of the first subset and of the third subset.

The complexity of the conversion of the modular additive mask of modulus q of the other partial input datum into a Boolean mask of said other partial input datum is C·log²(q)·p² with p the cardinal of the second subset and of the fourth subset.

Thus, n=m+p and therefore C·log₂(q)·n²>C·log²(q)·m²+C·log₂(q)·p².

Preferably, the first subset and second subset have cardinals the difference between which is less than or equal to 1. In other words, the difference between the cardinal of the first subset and the cardinal of the second subset is preferably less than or equal to 1.

Even more advantageously, when n is even, the cardinal of the first subset is equal to the cardinal of the second subset.

The saving in computational resources of the electronic device is thus optimal.

Typically, when m=p,

$$C \cdot {log}_{2} ( q ) \cdot {m}^{2} + C \cdot {log}_{2} ( q ) \cdot {p}^{2} = ( \frac{C}{2} ) \cdot {log}_{2} ( q ) \cdot {n}^{2} .$$

With the mask conversion techniques known to those skilled in the art, the conversions of masks of the partial input datum and of the other partial input datum thus consume two times fewer computing resources of the electronic device than conversion of the mask of the input datum.

The step of determining the third set may treat all the intermediate data of the second set as shares of the same Boolean mask although said intermediate data are not.

This is made possible by the step of determining a second set of n intermediate data as described above because the result of the combination via an exclusive-or of the first result and of the second result is equal to 0 if the input datum is equal to 0 and to a non-zero value if the input datum is not equal to 0.

In other words, this is enabled by a feature of the second set determined during the method, i.e. by the fact that the second set of n intermediate data has a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0, i.e. if and only if the input datum is equal to 0.

The second set determined during the method also has the feature that its partition into the first subset and the second subset is such that:
the first result is equal to a sum modulo the modulus q of the first shares of the third subset, and
the second result is equal to a sum modulo the modulus q of the opposites of the first shares of the fourth subset.

The method is also advantageous because it allows the use of any modulus q, i.e. a modulus q that is not a prime number.

1. A method for carrying out secure comparison with zero of a masked input datum taking a form of a first set of n first shares of a modular additive mask, n being an integer strictly greater than 1, the method being implemented by an electronic device (2) and the method comprising:
determining a second set of n intermediate data from the n first shares;
determining a third set of third shares of a Boolean mask of a result of the comparison from the intermediate data,
wherein the determining the second set of n intermediate data from the n first shares further includes determining a second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0.

2. The method for carrying out secure comparison with zero according to claim 1, wherein:
the modular additive mask is of non-zero modulus q,
the first result is equal to a sum modulo the modulus q of the first shares of a third subset,
the second result is equal to a sum modulo the modulus q of opposites of the first shares of a fourth subset, and
the third subset and the fourth subset being a partition of the first set.

3. The method for carrying out secure comparison with zero according to claim 1, wherein:
n is equal to 2,
intermediate datum of the first subset is a first share, and
the intermediate datum of the second subset is the opposite modulo a modulus q of a first share distinct from the first share of the first subset.

4. The method for carrying out secure comparison with zero according to claim 2, wherein:
n is strictly greater than 2,
the intermediate data of the first subset are a Boolean mask of a partial input datum, the first shares of the third subset being a modular additive mask of modulus q of the partial input datum, and
the intermediate data of the second subset are a Boolean mask of another partial input datum, the opposites modulo the modulus q of the first shares of the fourth subset being a modular additive mask of modulus q of the other partial input datum.

5. The method for carrying out secure comparison with zero according to claim 2, wherein the determining the second set of n intermediate data from the n first shares further comprises:
determining the third subset and the fourth subset;
determining the intermediate data of the first subset by applying an algorithm for converting a modular additive mask into a Boolean mask to the first shares of the third subset; and
determining the intermediate data of the second subset by applying an algorithm for converting a modular additive mask into a Boolean mask to the opposites modulo the modulus q of the first shares of the fourth subset.

6. The method for carrying out secure comparison with zero according to claim 1, wherein the first subset and the second subset have a cardinal difference less than or equal to 1.

7. The method for carrying out secure comparison with zero according to claim 1, wherein the determining the third set treats all the intermediate data of the second set as second shares of a Boolean mask.

8. The method for carrying out secure comparison with zero according to claim 1, wherein:
each intermediate datum has a size of k bits and a rank i of between 1 and n, k being strictly greater than 1,
each third share has a size of 1 bit and a rank i of between 1 and n,
determining the third set of the third shares comprises implementing an initialization of one third share of the third set to 1 and of the other third shares of said third set to 0, then updating an intermediate datum of same rank as the third share initialized to 1, with a one's complement of said intermediate datum of same rank, then implementing k substeps of updating the third shares of the third set, said updating substeps having respective indices ranging from 0 to k−1, each substep performing a calculation defined as follows:
$$( {b}_{1} , … , {b}_{n} ) ← SecAnd ( 1 , ( {b}_{1} , … , {b}_{n} ) , ( {y}_{1}^{j} , … , {y}_{n}^{j} ) )$$
with SecAnd a secure implementation of Boolean operator AND, yᵢ^{j} the bit of rank j of the intermediate datum of rank i, bᵢ the third share of rank i, j having as value index of the substep in question.

9. The method for carrying out secure comparison with zero according to claim 8, wherein the secure implementation of Boolean operation AND of the substep of index j updates the third shares such that:
$${⊕}_{i = 1}^{n} {b}_{i} = ( {⊕}_{i = 1}^{n} {b}_{i} ) ∧ ( {⊕}_{i = 1}^{n} {y}_{i}^{j} )$$
with ⊕ the exclusive-or operation and ∧ the Boolean operator AND.

10. The method for carrying out secure comparison with zero according to claim 1, wherein the secure comparison being implemented in a cryptographic algorithm.

11. The method for carrying out secure comparison with zero according to claim 10, wherein the cryptographic algorithm is an algorithm among Hamming Quasi-Cyclic algorithm, FrodoKEM algorithm and Crystals-Kyber algorithm.

12. A non-transitory computer readable medium having stored thereon a computer program having instructions executable by a processor and configured to implement a method according to claim 1, when these instructions are executed by the processor.

13. An electronic device capable of carrying out secure comparison with zero of a masked input datum taking au form of a first set of n first shares of a modular additive mask, n being an integer strictly greater than 1, the electronic device comprising:
processing circuitry configured to:
determine a second set of n intermediate data from the n first shares,
determine a third set of third shares of a Boolean mask of a result of the comparison from the intermediate data, wherein
the processing circuitry is further configured to determine the second set of n intermediate data by being configured to determine a second set of n intermediate data having a partition into a first subset and a second subset that are such that a first result obtained by combination with exclusive-or operations of zero and of the intermediate data of the first subset is equal to a second result obtained by combination with exclusive-or operations of zero and of the intermediate data of the second subset, when and only when the input datum is equal to 0.

14. The method for carrying out secure comparison with zero according to claim 2, wherein:
n is equal to 2,
intermediate datum of the first subset is a first share, and
the intermediate datum of the second subset is the opposite modulo the modulus q of a first share distinct from the first share of the first subset.

15. The method for carrying out secure comparison with zero according to claim 4, wherein the determining the second set of n intermediate data from the n first shares further comprises:
determining the third subset and the fourth subset;
determining the intermediate data of the first subset by applying an algorithm for converting a modular additive mask into a Boolean mask to the first shares of the third subset; and
determining the intermediate data of the second subset by applying an algorithm for converting a modular additive mask into a Boolean mask to the opposites modulo the modulus q of the first shares of the fourth subset.

16. The method for carrying out secure comparison with zero according to claim 2, wherein the first subset and the second subset have a cardinal difference less than or equal to 1.

17. The method for carrying out secure comparison with zero according to claim 3, wherein the first subset and the second subset have a cardinal difference less than or equal to 1.

18. The method for carrying out secure comparison with zero according to claim 4, wherein the first subset and the second subset have a cardinal difference less than or equal to 1.

19. The method for carrying out secure comparison with zero according to claim 5, wherein the first subset and the second subset have a cardinal difference less than or equal to 1.

20. The method for carrying out secure comparison with zero according to claim 2, wherein the determining the third set treats all the intermediate data of the second set as second shares of a Boolean mask.
